(19) United States
(12) Patent Application Publication
(10) Pub. No.: US 2022/0408734 A1
(43) Pub. Date: Dec. 29, 2022

(54) HYBRID SOLVENTS AND FABRICS FOR ANTIMICROBIAL APPLICATION

(71) Applicant: United Arab Emirates University, AI-Ain (AE)

(72) Inventors: Pranay RANJAN, Al-Ain (AE); Md. Zishan AKHTER, Al-Ain (AE); Jeyaganesh DEVARAJ, Al-Ain (AE)

(21) Appl. No.: 17/849,115

(22) Filed: Jun. 24, 2022

Related U.S. Application Data
(60) Provisional application No. 63/214,487, filed on Jun. 24, 2021.

(51) Int. Cl. A01N 65/48; A01N 65/28; A01N 65/26; A01N 65/10; A01N 65/24; A01N 37/36; A01N 63/50; A01P 1/00

(52) U.S. Cl. CPC A01N 65/48; A01N 65/28; A01N 65/26; A01N 65/10; A01N 65/24; A01N 37/36; A01N 63/50; A01P 1/00

(57) ABSTRACT

A novel hybrid non-alcoholic solvent solution and fabric for antimicrobial applications provides a non-toxic, economical, biodegradable, anti-microbial solution, that not only inhibits the growth but also kills microbial pathogens. In certain embodiments, the hybrid solvent composition includes extracts of curcumin, Syzygium aromaticum, Azadirachta indica, Trachyspermum Ammi, Cinnamomum Camphora, Cinnamomum Verum, and Elettaria Cardamomum.

### CROSS-REFERENCE TO RELATED APPLICATIONS AND PRIORITY

This patent application claims priority from U.S. Provisional Patent Application No. 63/214,487 filed Jun. 24, 2021. This patent application is herein incorporated by reference in its entirety.

### TECHNICAL FIELD

The present invention relates to hybrid solvents and fabrics for antimicrobial application.

### BACKGROUND OF THE INVENTION

Infectious diseases caused by pathogens such as viruses and bacteria are life-threatening to human race. The transmission rate of pathogens/germs is very high. The shelf-life of such microbes have been observed to increase due to the existence of suitable ambient conditions like temperature and humidity, and favorable pH-values of various surfaces in natural ambiance. These pathogens can severely damage cells and in certain cases are fatal to humans. Alcohol and UV-rays based solutions are commonly used for anti-microbial applications, but they are linked with toxicity over prolonged use.

Phytotherapy, once regarded as the backbone of medical science in the treatment of various contagious and communicable diseases, is a primitive yet influential way to treat infections caused by pathogens. The Neanderthals in present-day Iraq discovered its utility as early as 60,000 years ago [1-3]. The use of herbs got restricted due to the inception of antibiotics in the late 1950s. Antibiotics proved detrimental for the growth and development of herbal medicines by offering quick diagnosis, which had limited-period effectiveness and had several side-effects such as diarrhea, headache, ulcers, fever, nausea, bleeding, etc. However, microbiologists have been constantly attracted towards herbs for their antimicrobial properties, which usually cause no side-effects, especially edible herbs. Early 1990s era marked the commencement of research and application on medicinal plants for the treatment of several infections and diseases [4-6].

There are nearly 250,000 to 500,000 species of plants on earth [7], out of which, nearly 1% to 10% are considered to be edible for humans. However, the medicinal plant's number can differ significantly in comparison to edible plants sources [8]. Antimicrobial property of herbs and plants has been the driving factor for research in the past 20 years [9]. The scientific discipline of ethnopharmacology or ethnobotany was created to collect and review all the available plant-based research and developments done by indigenous people and is nowadays a comprehensive source [10-13]. The rise of the various viruses, fungi and bacteria, motivated the microbiologist to go for plant-based organic herbs and their uses for phytotherapy. Advancement in medical science and technological achievements has provided a derivative path to use various herbal remedies for several infectious diseases. Herbs are readily available and used almost everywhere due to their economical, safer and non-toxic properties. These herbs contain antimicrobial (antibacterial, antifungal and antiviral) properties due to the presence of alkaloids, tannins, essential oils, flavonoids, lectins, quinones, coumarins, polyphenols and phenolic compounds, enzymes, and many other active principles [3].

The invention of the present disclosure proposes unique hybrid solvents with antimicrobial properties and a novel biodegradable fabric which is coated, sprayed, embedded, doped with the proposed solvents to provide protection against transmission and infection of contagious diseases by inhibiting and killing microbes within the fabric matrix.

### SUMMARY OF THE EMBODIMENTS

In representative embodiments, the present invention is directed at a novel non-alcoholic solvent composition for anti-microbial use.

The present invention discloses a non-toxic, economical, biodegradable, anti-microbial solution, that not only inhibits the growth but also kills microbial pathogens.

Disclosed herein is a non-alcoholic solvent composition comprising plant extracts and non-plant ingredients having anti-microbial properties.

In certain embodiments, disclosed herein is a hybrid solvent composition comprising extracts of curcumin, Syzygium aromaticum, Azadirachta indica, Trachyspermum Ammi, Cinnamomum Camphora, Cinnamomum Verum, and Elettaria Cardamomum.

In further embodiments, provided herein is a hybrid solvent composition that further comprises non-plant active ingredients like citric acid, Atlantic cod (Gadus morhua) trypsin, glycerol, and sodium chloride.

In further embodiments, provided herein is a solvent composition comprising a wide variety of plant extracts, like curcumin, Syzygium aromaticum, Azadirachta indica, Trachyspermum Ammi, Cinnamomum camphora, Cinnamomum verum, Elettaria cardamomum and non-plant ingredients, like citric acid, Atlantic cod trypsin, glycerol, and sodium chloride and derived mixtures, solvents, oils and their hybrids respectively.

In further embodiments, provided herein is a non-alcholic solvent composition, or a non-alcoholic solvent or solvent mixture with a certain specific bactericidal efficacy of at least 95%.

Further disclosed is a novel biodegradable fabric which is coated or embedded or embossed with the proposed solvents to provide protection against transmission and infection of contagious diseases by trapping and killing viruses or bacteria or fungi or yeast within the fabric matrix.

### BRIEF DESCRIPTION OF THE FIGURES

TABLE. 1 illustrates examples of preferred mixtures of the hybrid solvents of the present invention.

FIG. 1 illustrates the solvent extracted from the fabric.

FIG. 2 illustrates the results of the anti-bactericidal activity test.

FIGS. 3-4 illustrate Bacillus L. growth inhibition in Agar well diffusion test.

FIGS. 5-6 illustrate Bacillus G. growth inhibition in Agar well diffusion test.

FIGS. 7-8 illustrate Archaeal strain growth inhibition in Agar well diffusion test.

FIGS. 9A-9B illustrate antimicrobial activity by modified minimum inhibitory concentration method.

### DETAILED DESCRIPTION OF SPECIFIC EMBODIMENTS

The present invention discloses novel non-alcoholic based hybrid solvents to provide a new strategy to enhance antimicrobial activity using plant and non-plant ingredients.

The advantage of these novel novel non-alcoholic based hybrid solvent or solvent composition is that it has effective antimicrobial properties, it is easy to use, it is non-toxic, biodegradable, and economical.

In a first embodiment of the present disclosure, the non-alcoholic hybrid solvent or solvent composition of the present invention is a mixture of different plant extracts comprising Curcumin, Syzygium aromaticum, Azadirachta indica, Trachyspermum Ammi, Cinnamomum camphora, Cinnamomum verum, Elettaria cardamomum.

In a preferred embodiment of the present disclosure, the non-alcoholic hybrid solvent of the present invention is a mixture of different plant extracts comprising Curcumin, Syzygium aromaticum, Azadirachta indica, Trachyspermum Ammi, Cinnamomum camphora, Cinnamomum verum, Elettaria cardamomum and non-plant ingredients comprising citric acid, Atlantic cod trypsin, glycerol, and sodium chloride.

In a preferred embodiment glycerol is in the form of glycerol monolaurate.

In a second embodiment of the present disclosure, the hybrid solvent is a non-alcoholic mixture of plants extracts and non-plant ingredients.

In a third embodiment of the present disclosure, the non-alcoholic hybrid solvent of the present invention is a mixture of Curcumin, Syzygium aromaticum, Azadirachta indica, Trachyspermum Ammi, Cinnamomum camphora, Cinnamomum verum, Elettaria cardamomum, citric acid, Atlantic cod trypsin, glycerol, and sodium chloride in which each component of the mixture is less than or equal to 50% of the volume of the total composition.

In a sixth embodiment of the present disclosure, the solvent solution comprises least three ingredients of the mixture described above.

In a seventh embodiment of the present disclosure, the solvent solution comprises least two ingredients of the mixture described above.

In one embodiment of the present disclosure, the hybrid solvent is a non-alcoholic mixture comprising Trachyspermum Ammi extract in oil/water, Syzygium aromaticum extract in oil and curcumin.

In another embodiment of the present disclosure, the hybrid solvent is a non-alcoholic mixture comprising Trachyspermum Ammi extract in oil/water and curcumin.

In another embodiment of the present disclosure, the hybrid solvent is a non-alcoholic mixture comprising Trachyspermum Ammi extract in oil/water, Azadirachta indica extract in oil and curcumin.

In another embodiment of the present disclosure, the hybrid solvent is a non-alcoholic mixture comprising Trachyspermum Ammi in oil/water and Azadirachta indica extract in oil.

In another embodiment of the present disclosure, the hybrid solvent is a non-alcoholic mixture comprising curcumin and Azadirachta indica extracts in oil.

In another embodiment of the present disclosure, the hybrid solvent is a non-alcoholic mixture comprising Azadirachta indica extract in oil and Syzygium aromaticum extract in oil.

In another embodiment of the present disclosure, the hybrid solvent is a non-alcoholic mixture comprising curcumin and Syzygium aromaticum extract in oil.

In another embodiment of the present disclosure, the hybrid solvent is a non-alcoholic mixture comprising curcumin, Azadirachta indica extract in oil, Syzygium aromaticum extract in oil and Trachyspermum Ammi extracts in oil/water.

In another embodiment of the present disclosure, the hybrid solvent is a non-alcoholic mixture comprising curcumin, Azadirachta indica extract in oil, Syzygium aromaticum extract in oil, Trachyspermum Ammi extract in oil/water, Cinnamomum camphora and Cinnamomum verum.

In another embodiment of the present disclosure, the hybrid solvent is a non-alcoholic mixture comprising curcumin, Azadirachta indica extract in oil, Syzygium aromaticum extract in oil, Trachyspermum Ammi extract in oil/water, Cinnamomum camphora and Elettaria cardamomum.

In another embodiment of the present disclosure, the hybrid solvent is a non-alcoholic mixture comprising curcumin, Azadirachta indica extract in oil, Syzygium aromaticum extract in oil, Trachyspermum Ammi extract in oil/water and Cinnamomum camphora.

In another embodiment of the present disclosure, the hybrid solvent is a non-alcoholic mixture comprising Gadus morhua's trypsin, glycerol, citric acid and sodium chloride.

In another embodiment of the present disclosure, the hybrid solvent is a non-alcoholic mixture comprising Gadus morhua's trypsin, glycerol, citric acid, sodium chloride and curcumin.

In a second aspect of the present disclosure, the hybrid solvent is coated, embedded, sprayed, fogged, doped or sprinkled on various surfaces such as wood, plastic, steel, glass, ceramics, cellulose, cotton, polymerized fabric, for elimination and/or growth-restriction of microbes.

In a further aspect of the present disclosure, the methods used to apply the hybrid solvent or composition of the present invention to various surfaces is not limited by the above described nethods, but comprises any method that is known and available to a person of ordinary skill in the art.

In a further aspect of the present disclosure, the methods for oil and oil/water extraction are well known and available to a person of ordinary skill in the art.

In a further aspect of the present disclosure, the surfaces that can be coated with the hybrid solvent or composition of the present invention are not limited to the surfaces described above, but comprise any surface where the elimination and/or growth-restriction of microbes is desireable or needed.

In one embodiment of the present disclosure, the hybrid solvent is non-alcoholic.

In another embodiment of the present disclosure, the hybrid solvent is active in dry-mode.

In a preferred embodiment of the present disclosure, the hybrid solvent is a mixture of different plants comprising Curcumin extract, Syzygium aromaticum extract, Azadirachta indica extract, Trachyspermum Ammi extract, Cinnamomum camphora extract, Cinnamomum Verum extract, Elettaria cardamomum extract, and non-plant ingredients, like citric acid, Atlantic cod trypsin, glycerol and sodium chloride to be used as anti-microbial on a variety of surfaces and materials.

In a preferred embodiment of the present disclosure, the hybrid solvent, solvent or solvent mixture, has a the bactericidal efficacy is at least 95% on bacterial strains selected from the group consisting of: Staphylococcus aureus, Pseudomonas aeruginosa, Escherichia coli, and Enterococcus hirae according to the British Standards Institute 1276:2019 suspension test for evaluation of bactericidal activity of chemical disinfectants and antiseptics.

In a most preferred embodiment of the present disclosure, the hybrid solvent, solvent or solvent mixture, has a the bactericidal efficacy is at least 99% on bacterial strains selected from the group consisting of: Staphylococcus aureus, Pseudomonas aeruginosa, Escherichia coli, and Enterococcus hirae according to the British Standards Institute 1276:2019 suspension test for evaluation of bactericidal activity of chemical disinfectants and antiseptics.

In a preferred embodiment of the present disclosure, the hybrid solvent, solvent or solvent mixture, shows an inhibition of 17% viability of the SARS-CoV-2 virus.

In a preferred embodiment of the present disclosure, the hybrid solvent solution or composition comprises least two ingredients of the mixture to be applied for use as anti-microbial on a variety of surfaces and materials.

In a most preferred embodiment of the present disclosure, the hybrid solvent solution or composition comprises least three ingredients of the mixture to be applied for use as anti-microbial on a variety of surfaces and materials.

In a third aspect of the present disclosure, disclosed is a novel biodegradable fabric that is coated, embedded, embossed with the proposed hybrid solvents of the present invention to provide protection against transmission and infection of contagious diseases (such as Coronavirus) by trapping and killing viruses/bacteria/fungi/yeast within the fabric matrix.

In one embodiment of the present invention, the novel biodegradable fabric can be used as tissue paper, toilet paper, face towel, diaper, linen, surgical mask, surgical glove, polymerized fabric, leather, plastics, cotton, and rubber.

In a further aspect of the present disclosure, the materials suitable for use of the novel biodegradable fabric are not limited to the materials listed above, but comprise any material where the elimination and/or growth-restriction of microbes is desireable or needed.

In another embodiment of the present invention, the novel biodegradable fabric containing the hybrid solvent solution provides protection against transmission and infection of contagious diseases by inhibiting and killing microbes within the fabric matrix.

In another embodiment of the present invention, the novel biodegradable fabric can be used on sensitive areas like eyes, lips and nose avoiding skin dryness and not causing kidney or liver problem.

Materials and Methods

The present invention is a hybrid solvent obtained from a mixture of different plant extracts comprising Curcumin, Syzygium aromaticum, Azadirachta indica, Trachyspermum Ammi, Cinnamomum camphora, Cinnamomum Verum, Elettaria cardamomum, and inorganic and non-plant ingredients, like citric acid, Atlantic cod trypsin, glycerol and sodium chloride. Each ingredient of the composition was selected for its anti-microbial properties.

The antibacterial, aromaticity and safety property of Syzygium aromaticum (clove) against bacteria and fungi have been successfully demonstrated by Hu et al. [14] on foods products. Gram-negative and gram-positive bacteria such as Escherichia coli and Bacillus cereus have been observed to be inhibited and destroyed. It was also proven that Syzygium aromaticum works against fungi such as Aspergillus flavus, Aspergillus parasiticus, Aspergillus ochraceus and Penicillium [14] Moreover, Kovacs et al. [15] demonstrated the antiviral and antibacterial property of Syzygium aromaticum against C. jejuni pathogens. Another report by Kumar et al. [16] supports the antibacterial property of Syzygium aromaticum against Bacillus cereus and Staphylococcus aureus as well as Salmonella typhi and Escherichia coli bacteria. It was also claimed by Abdullah et al. [17] that Syzygium aromaticum is also used for preventing and eliminating Acinetobacter baumannii, Pseudomonas aeruginosa, Staphylococcus aureus and Enterococcus feacalis as well as two standard strains, Staphylococcus aureus ATCC29213 and Pseudomonas aeruginosa ATCC27853. Syzygium aromaticum was also tested against Herpes virus [18], and was found being very effective at 5m/mL.

Neem (Azadirachta indica A. Juss) oil was tested by Serrone et al. [19] against bacteria (Escherichia coli) aimed at applications in food additives, food packaging, as well as personal hygiene. It was observed to be effective and eradicated all kinds of E. coli bacteria present in different sections. The antibacterial, antimalarial, antiviral, and antifungal properties of Azadirachta indica A. Juss have been reported by Chauhan et al. [20-21]. Aqueous extracts of neem leaf and neem oil were used against HIV and Polio viruses for antiviral studies. The antibacterial property of Azadirachta indica has been verified on bacterial pathogens using agar well diffusion assay by Jacobson et al. [22]. Azadirachta indica is also deemed to possess anti-bacterial, anti-cariogenic, anti-helminthic, anti-diabetic, anti-oxidant, astringent, anti-viral, cytotoxic, and anti-inflammatory properties [23-25].

The antimicrobial effect of curcumin (turmeric) was tested on meals as preservative and antibacterial agent. It was found that curcumin was effective against Escherichia coli, Staphylococcus aureus, Salmonella typhi and Candida albicans bacteria [26]. Similar results were obtained by Chandrana et al. and Mohammad et al. [27-28]. Moreover, Teow et al. [29] have demonstrated the effectiveness of curcumin against methicillin-sensitive S. aureus (MSSA) and methicillin-resistant S. aureus (MRSA) and found the potential use of curcumin in overcoming such multidrug-resistant bacteria. It was further reported [30-31] that curcumin shows the promising antiviral property for inhibiting the HIV-1 LTR-directed gene expression without any major effects on cell viability.

The role of Trachyspermum Ammi (ajwain) for antiviral property has been demonstrated by Roy et al. [32]. In this seminal work, it was found that Trachyspermum Ammi can be used against the Japanese encephalitis virus. In another study, Trachyspermum Ammi (by Singh et al. [33]) has been used to eliminate fungi such as Aspergillus niger, Aspergillus flavus, Aspergillus oryzae, Aspergillus ochraceus, Fusarium monoliforme, Fusarium graminearum, Pencillium citrium, Penicillium viridicatum, Pencillium madriti, and Curvularia lunata. Likewise the active role of Cinnamomum camphora, Cinnamomum verum, Elettaria cardamomum have been observed for antimicrobial activity.

Besides organic solvents, non-plant ingredient, such as Atlantic cod (Gadus morhua) trypsin glycerol [34], citric acid [35-37] and sodium chloride [38] have also been used for antiviral, antifungal and antibacterial properties. It is claimed that Gadus morhua's trypsin inhibits and kills COVID-19 viruses when sprayed inside the nasal cavity. Moreover, several findings on Gadus morhua's trypsin have been reported [34] concerning inhibitive activities against influenza virus. It has also been proven to be very effective against Herpes simplex virus type 1 (HSV-1) and the respiratory syncytial virus (RSV) [34].

Proposed is here a novel non-alcoholic based hybrid solvents which will provide a new strategy to enhance antimicrobial activity using organic and inorganic extracts. The products (solvents and fabric) hold the potential for wide applications in various industries (tissue paper and diapers, food and beverages (F&B), textile, perfumes and spray, healthcare and medicines, paper and pulp, leather, footwear, plastic, rubber. etc.). The application of formulated solvents (in the defined composition) is novel and has not been applied (on tissue paper, fabrics, etc.) to inhibit the growth and transmission of contagious microbes.

The invention of the present disclosure is a unique hybrid solution for antimicrobial properties that extends its application over a wide range of industries.

The present disclosure discloses a non-alcoholic hybrid solvent composition, unlike commercial antimicrobial wipes and sanitizers. Further, the hybrid solvent is non-toxic, non-allergic and is biodegradable.

A novelty of the present invention is its activation under dry-mode to perform antimicrobial activities, while popularly used wipes and sanitizers work under wet mode.

The proposed invention of the present disclosure is a mixture of selected different plant extracts (such as Curcumin, Syzygium aromaticum, Azadirachta indica, Trachyspermum Ammi, Cinnamomum camphora, Cinnamomum Verum, Elettaria cardamomum), and non-plant ingredients (citric acid, Atlantic cod trypsin, glycerol and sodium chloride).

End-use application areas for the fabric of the present invention include, for example tissue papers (tissues, face towels, toilet papers) and diapers, food and beverages (wraps, boxes, and covers), textile (hospital linen), perfumes and sprays (fragrance, air-fresheners, and disinfectants), healthcare (surgical masks, gloves, and PPE kits), paper and pulp, leather, footwear, plastic, rubber, plants, and soils, among others, but not limited to the listed applications.

Methods of preparing the hybrid solvent or solvent compositions including the steps of:

(1) Intercalation—All the plant and inorganic/organic materials were dispersed in two different media, (1) water, or (2) an alcohol mixture. The alcohol mixture is a mixture of alcohol and water, where the concentration of alcohol ranges from 10% to 99% vol/vol, and preferably from 60% to 95%, according to methods well known in the art.

The materials dispersed have been left under a sealed container overnight and been used for extraction the next day (after 12 h).

(2) Extraction—The overnight dispersed materials in aqueous media were mixed and stirred, with constant heating to maintain the temperature between 100° C. to 150° C. The reaction was optimized based on the results obtained during the evaluation of intermediate solvent extracted after termination.

(3) Termination—After completion of the reaction, a separate mixture of—OH functionalized curcumin was added along with camphor oil to the solution.

Embedding process for the integration of the hybrid solvent composition of the present invention in the fabric matrix:

(a) The technique involves using auto jet spray control or fogging/spraying (compressed air and a pressurized or siphoned liquid) through the cold-pressed roller lubrication. The biodegradable/tissue papers are exposed to the solvent followed by hot air drying.
(b) Alternatively, the embedding of tissues with solvent is also performed through dip coating and/or spin coating. The addition of solvent to the fabric can be tuned according to the customization. In general, the procedure operates at an rpm<500, and speed>=0.1 mm/s for spin and dip coating, respectively.
(c) Eventually, the solvent is dried in a controlled ambience.

Experimental Examples

The novel solvent composition has been tested against a range of bacteria, viruses, fungi and yeast. The inhibition rate of the solvent has been observed to be greater than 95% on bacteria, fungi and yeasts. Further, the efficacy on virus (SARS Cov-2) has been tested to be 17% in the 1^{st} phase of trials.

Antimicrobial Efficiency Test

An antimicrobial efficacy study was performed to determine the bactericidal activity of the chemical disinfectant of the present invention.

For this study, a standard method is used describing describes a suspension test method for establishing whether a chemical disinfectant possess bactericidal activity. The standard refers to the parameters to be observed when testing products for general disinfection in the food, industrial, domestic, andinstitutional areas. The test considers practical conditions of application of the product, including contact time, temperature, test organisms and interfering substance which may influence its action in practical situations.

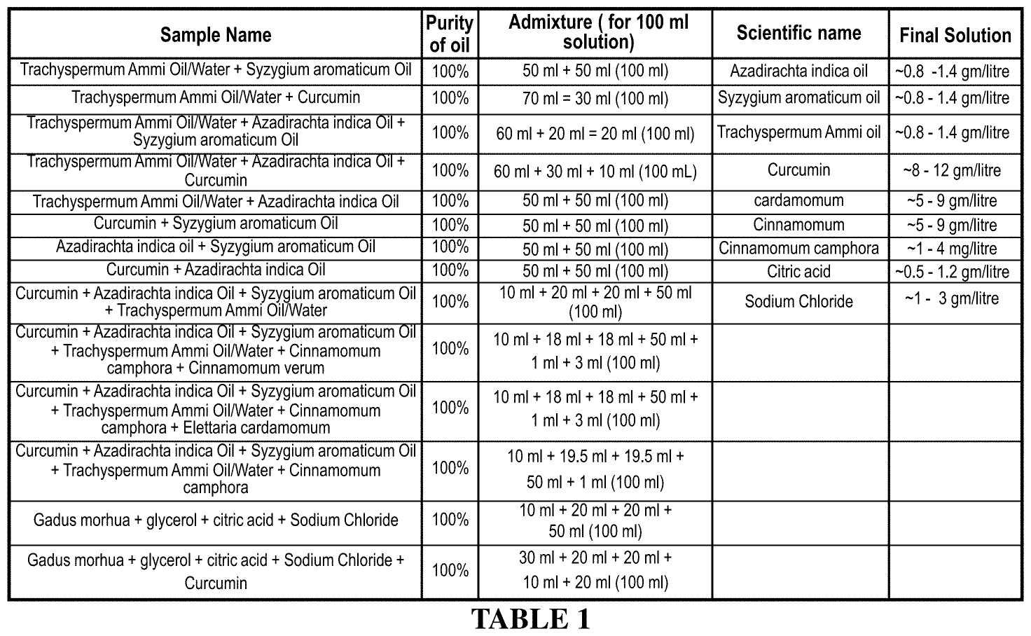

To determine the antimicrobial efficiency of the tissue paper/fabrics (on the microbes) embedded with our solvent, we first extracted the solvent from the fabric (FIG. 1).

Procedure to extract the solvent from the fabric:

(1) The fabric containing the solvent was soaked in the double distilled water (D.I. water) for 8 hours and then the solvent was filtered using whatman filter paper to remove any particulates from the fabric.

(2) The solvent was then used for testing against anti-microbial activity. To begin with we have tested our solvent at the Abu Dhabi Quality and Conformity Council, Abu-Dhabi, with the standard method of the British Standards Institute (BS EN 1276:2019). This describes a suspension test method for establishing whether a chemical disinfectant possess anti-bactericidal activity. The standard refers to the parameters to be observed when testing products for general disinfection in the food, industrial, domestic, and institutional areas. The test considers practical conditions of application of the product, including contact time, temperature, test organisms and interfering substance which may influence its action in practical situations.

Experimental Conditions:

| | |
|---|---|
| Product diluent | Not Applicable |
| Contact time | 5 Minutes |
| Test temperature | 20 Deg C. |
| Interfering substance | 3% Bovine Albumin |
| Incubation temperature | 37 Deg C. |
| Neutralizer | Polysorbate 80 |

The test is performed using Staphylococcus aureus ATCC 6538, Pseudomonas aeruginosa ATCC15542, Escherichia coli ATCC 10536, and Enterococcus hirae ATCC 10541 strains as standard organisms.

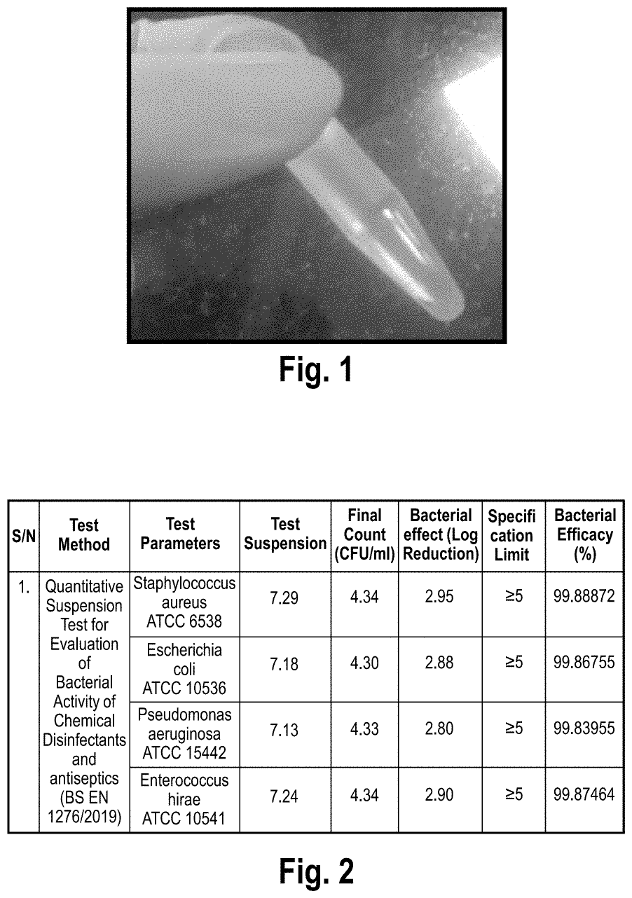

Bactericidal efficacy is above 99.8% for each strain utilized for the test, as shown in FIG. 2.

Agar Well Diffusion Test

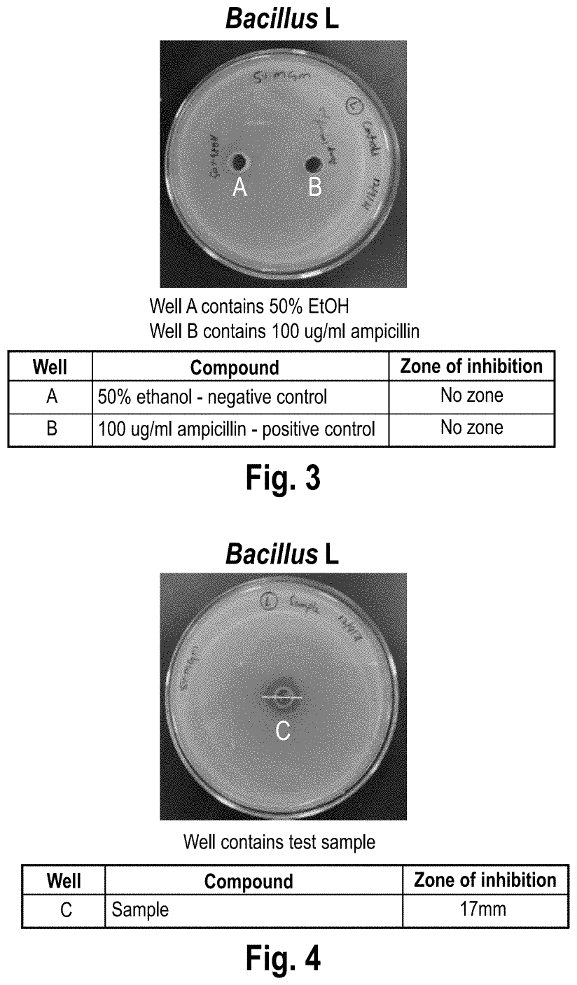

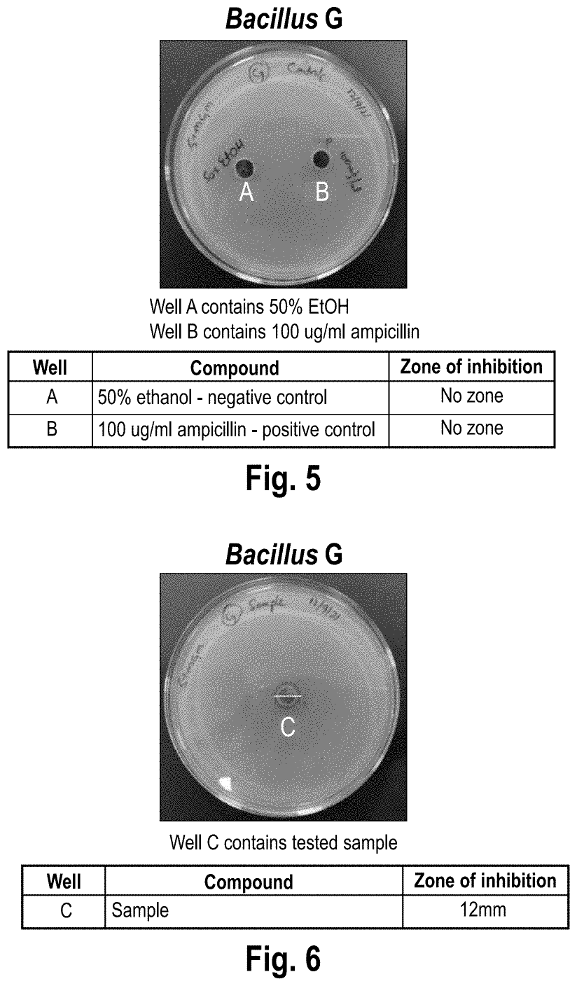

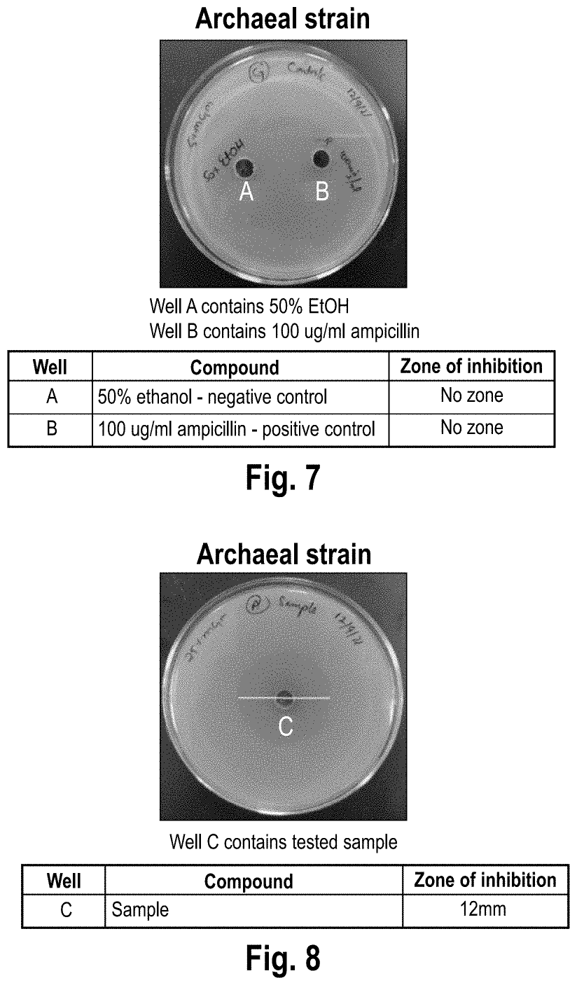

Agar well diffusion method (FIGS. 3-7).
(1) The sample was tested against Escherichia coli 2 Bacillus strains and an archaeal strain for antimicrobial activity determination.
(2) Microbial inoculum were prepared prior to the test (overnight cultures).
(3) Agar well diffusion method was used to determine the zone of inhibition of the compound using CLSI guidelines.
(4) Ampicillin 100 ug/ml and 50 EtOH were used as positive and negative controls, respectively.
(5) Plates were incubated for 24 hours at 37° C. The zone of inhibition was observed and measured in mm.

Modified Minimum Inhibitory Concentration Test

Evaluation of antimicrobial activity by modified minimum inhibitory concentration method
(1) Microbial cultures were 10000 diluted for this experiment.
(2) The procedure was repeated by decreasing the concentration of antibiotic and increasing the volume of test sample against E coli and Bacillus.

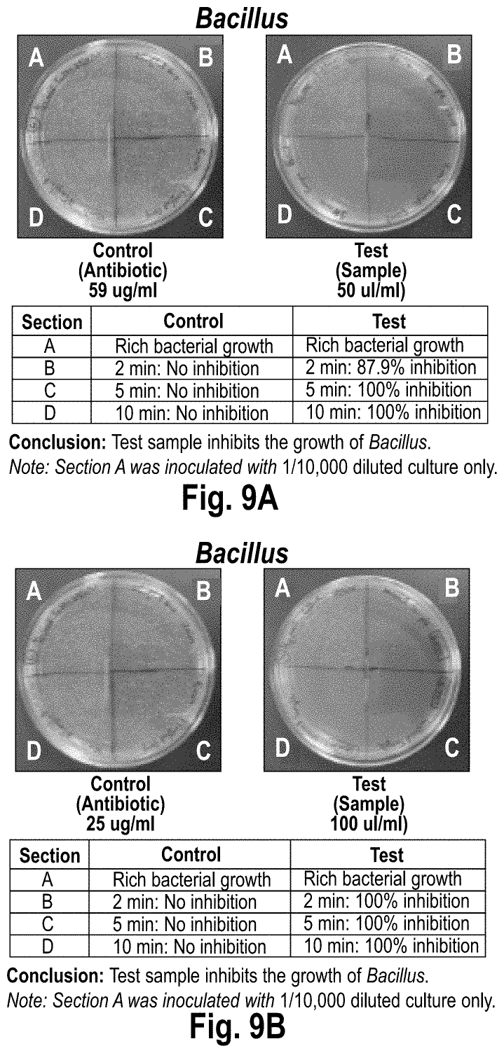

The reported results in FIGS. 9A-9B from our research lab demonstrate that the solvent exhibits antimicrobial properties. The percentage of efficacies are also connotes that the novel solvent inhibits 100% growth of the microbes in 2, 5, and 10 mins time interval.

The results shown refer to the bacterial strain, while for the SARS-CoV-2 strain the same sample have been sent to the Translational Health Science and Technology Institute, NCR Biotech Science Cluster, 3^{rd} Milestone, Faridabad-Gurgaon Expressway, Faridabad, India for laboratory testing and an inhibition of 17% have been found on the SARS-CoV-2 strain.

### Definitions

As used in this description and the accompanying claims, the term “substantially free of any alcohol” means not more than 0.1% alcohol.

As used in this description and the accompanying claims, the term “hybrid solvent” is a non-alcoholic mixture, or a solvent or solvent mixture, and “hybrid solvent is a non-alcoholic mixture” is used interchangeably with “non-alcoholic solvent or solvent mixture.”

As used in this description and the accompanying claims, the term “mg/kg” or “mg/L” is equivalent to “ppm,” “μg/kg” and “μg/L” is equivalent to “ppb.”

### REFERENCES

[1] Stockwell, C. 1988. Nature's pharmacy. Century Hutchinson Ltd., London, United Kingdom.
[2] Thomson, W. A. R. (ed.). 1978. Medicines from the Earth. McGraw-Hill Book Co., Maidenhead,
United Kingdom
[3] CLINICAL MICROBIOLOGY REVIEWS, 12, 4, 1999, 564-582
[4] Clark, A. M. 1996. Natural products as a resource for new drugs. Pharm. Res. 13:1996.
[5] Alper, J. 1998. Effort to combat microbial resistance lags. ASM News 64:440-441.
[6] Klink, B. 1997. Alternative medicines: is natural really better? Drug Top. 141:99-100.
[7] Borris, R. P. 1996. Natural products research: perspectives from a major pharmaceutical company. J. Ethnopharmacol. 51:29-38.
[8] Moerman, D. E. 1996. An analysis of the food plants and drug plants of native North America. J. Ethnopharmacol. 52:1-22.
[9] Lewis, W. H., and M. P. Elvin-Lewis. 1995. Medicinal plants as sources of new therapeutics. Ann. Mo. Bot. Gard. 82:16-24.
[10] Georges, M., and K. M. Pandelai. 1949. Investigations on plant antibiotics. IV. Further search for antibiotic substances in Indian medicinal plants. Indian J. Med. Res. 37:169-181.
[11] Rojas, A., L. Hernandez, R. Pereda-Miranda, and R. Mata. 1992. Screening for antimicrobial activity of crude drug extracts and pure natural products from Mexican medicinal plants. J. Ethnopharmacol. 35:275-283.
[12] Silva, O., A. Duarte, J. Cabrita, M. Pimentel, A. Diniz, and E. Gomes. 1996. Antimicrobial activity of Guinea-Bissau traditional remedies. J. Ethnopharmacol. 50:55-59.
[13] Vanden Berghe, D. A., A. J. Vlietinck, and L. Van Hoof. 1986. Plant products as potential antiviral agents. Bull. Inst. Pasteur 84:101-147.
[14] Qiao Hu, Meifang Zhou, and Shuyong Wei, Progress on the Antimicrobial Activity Research of Clove Oil and Eugenol in the Food Antisepsis, Journal of Food Science, 83, 6, 2018.
[15] Kovacs et al., Antimicrobial and Virulence-Modulating Effects of Clove Essential Oil on the Foodborne Pathogen Campylobacter jejuni, Applied and Environmental Microbiology, 20, 82, 2016.
[16] Kumar et al., Antibacterial activity of Clove (Syzygium aromaticum) and Garlic (Allium sativum) on different pathogenic bacteria, Int. J. Pure App. Biosci. 2 (3): 305-311 (2014).
[17] Abdulhha et al. A Comparative Study of the Antibacterial Activity of Clove and Rosemary Essential Oils on Multidrug Resistant Bacteria, UK Journal of Pharmaceutical and Biosciences Vol. 3(1), 18-22, 2015.
[18] Kurokawa M, Hozumi T, Basnet P, Nakano M, Kadota S, Namba T, et al. Purification and characterization of eugeniin as an antiherpesvirus compound from Geum japonicum and Syzygium aromaticum. J Pharmacol Exp Ther 1998; 284(2): 728-735.
[19] Serrone et al., Neem (Azadirachta indica A. Juss) Oil to Tackle Enteropathogenic Escherichia coli, Hindawi Publishing Corporation, BioMed Research International, 2015, 343610, 10.
[20] Chauhan et al. The Antibacterial Activities of Neem [Azadirachta Indicia] Seed Oil, A Review, IOSR Journal of Applied Chemistry, 2278-5736, 11, 5, 2018 58-63.
[21] Rao, A. D., Devi, K. N. and Thyagaraju, K., J. Enzyme Inhib., 1998.
[22] Jacobson, M., in The Neem Tree: Source of Unique Natural Products for Integrated Pest Management, Medicine, Industry and Other Purposes (ed. Schmutterer, H.), 1995.
[23] Lakshmi et al., Azadirachta indica: A herbal panacea in dentistry—An update, Pharmacognosy Reviews, 2015, 9, 17.
[24] Alzohairy et al., Therapeutics Role of Azadirachta indica (Neem) and Their Active Constituents in Diseases Prevention and Treatment, Hindawi Publishing Corporation, Evidence-Based complementary and Alternative Medicine, 2016, 7382506, 11.
[25] Strader et al., Hepatotoxicity of Herbal Preparations, Zakim and Boyer's Hepatology, 462-475, 2012.
[26] Gul et al. Antimicrobial activity of turmeric extract and its potential use in food industry, J Food Sci Technol, 2015, 52(4), 2272-2279.
[27] Chandrana H, Baluja S, Chanda S V (2005) Comparison of antibacterial activities of selected species of Zingiberaceae family and some synthetic compounds. Turk J Biol 29(29):83-97.
[28] Mohammad R I, Rubina A, Obaidur R, Mohammad A, Akbar M A, Al-Amin M, Alam K D, Lyzu F (2010) In vitro antimicrobial activities of four medicinally important plants in Bangladesh. Eur J Sci Res 39:199-206.
[29] Teow et al. Antibacterial Action of Curcumin against Staphylococcus aureus: A Brief Review, Hindawi Publishing Corporation, Journal of Tropical Medicine, 2016, 2853045, 10.
[30] Moghadamtousi et al. A Review on Antibacterial, Antiviral, and Antifungal Activity of Curcumin, Hindawi Publishing Corporation, BioMed Research International, 2014, 186864, 12.
[31] S. Kaur, N. H. Modi, D. Panda, and N. Roy, “Probing the binding site of curcumin in Escherichia coli and Bacillus subtilis FtsZ—a structural insight to unveil antibacterial activity of curcumin,” European Journal of Medicinal Chemistry, 45, 9, 4209-4214, 2010.
[32] Soumen Roy et al., Evaluation of antiviral activity of essential oil of Trachyspermum Ammi against Japanese encephalitis virus, Pharmacognosy Res., 2015; 7(3): 263-267.
[33] Singh et al., Chemical Constituents, Antifungal and Antioxidative Effects of Ajwain Essential Oil and Its Acetone Extract, J. Agric. Food Chem. 2004, 52, 3292-3296.
[34] Gudmundsdóttir et al., Potential Use of Atlantic Cod Trypsin in Biomedicine, Hindawi Publishing Corporation, BioMed Research International, 2013, 749078, 11.
[35] Ekawati et al., Lemon (Citrus limon) Juice Has Antibacterial Potential against Diarrhea-Causing Pathogen, 2019 IOP Conf. Ser.: Earth Environ. Sci. 217 012023.
[36] Oikeh et al., Phytochemical, antimicrobial, and antioxidant activities of different citrus juice concentrates, Food Science & Nutrition 2016; 4(1): 103-109.
[37] Brochot et al., Antibacterial, antifungal, and antiviral effects of three essential oil blends, Microbiology, 2017, 6, 459.
[38] Muñoz et al., High Concentrations of Sodium Chloride Improve Microbicidal Activity of Ibuprofen against Common Cystic Fibrosis Pathogens, Pharmaceuticals 2018, 11, 47.

1. A novel non-alcoholic solvent or solvent mixture, wherein
the solvent composition comprises at least one ingredient selected from the group consisting of
curcumin extract,
Syzygium aromaticum extract,
Azadirachta indica extract,
Trachyspermum Ammi extract,
Cinnamomum Camphora extract,
Cinnamomum Verum extract,
Elettaria Cardamomum extract,
citric acid,
Atlantic cod trypsin,
glycerol,
sodium chloride,
and combinations thereof.

2. The solvent or solvent mixture of claim 1, wherein:
Curcumin extract, is less than or equal to 50% by weight,
Syzygium aromaticum extract, is less than or equal to 50% by weight,
Azadirachta indica extract, is less than or equal to 50% by weight,
Trachyspermum Ammi extract, is less than or equal to 50% by weight,
Cinnamomum Camphora extract, is less than or equal to 50% by weight,
Cinnamomum Verum extract, is less than or equal to 50% by weight,
Elettaria Cardamomum extract, is less than or equal to 50% by weight,
citric acid is less than or equal to 50% by weight,
Atlantic cod trypsin is less than or equal to 50% by weight,
glycerol is less than or equal to 50% by weight,
sodium chloride is less than or equal to 50% by weight.

3. The solvent or solvent mixture of claim 1, wherein the solvent solution comprises at least three ingredients selected from the group consisting of curcumin extract, Syzygium aromaticum extract, Azadirachta indica extract, Trachyspermum Ammi extract, Cinnamomum Camphora extract, Cinnamomum Verum extract, Elettaria Cardamomum extract, citric acid, Atlantic cod trypsin, glycerol, and sodium chloride.

4. The solvent or solvent mixture of claim 1, wherein the solvent solution comprises at least two ingredients selected from the group consisiting of curcumin, Syzygium aromaticum extract, Azadirachta indica extract, Trachyspermum Ammi extract, Cinnamomum Camphora extract, Cinnamomum Verum extract, Elettaria Cardamomum extract, citric acid, Atlantic cod trypsin, glycerol, and sodium chloride.

5. The solvent or solvent mixture of claim 1, wherein the solution comprises at least one plant extract in oil such a flavonoid and herbal oil.

6. The solvent or solvent mixture of claim 1, wherein the solution comprises at least one plant extract in oil and water.

7. The solvent or solvent mixture of claim 5, wherein the composition comprises water.

8. The solvent or solvent mixture of claim 1, wherein the composition is substantially free of any alcohol.

9. The solvent or solvent mixture of claim 1, wherein the bactericidal efficacy is at least 95% on bacterial strains selected from the group consisting of: Staphylococcus aureus, Pseudomonas aeruginosa, Escherichia coli, and Enterococcus hirae according to the British Standards Institute 1276:2019 suspension test for evaluation of bactericidal activity of chemical disinfectants and antiseptics.

10. The solvent or solvent mixture of claim 9, wherein the bactericidal efficacy is at least 99% on bacterial strains selected from the group consisting of: Staphylococcus aureus, Pseudomonas aeruginosa, Escherichia coli, and Enterococcus hirae according to the British Standards Institute 1276:2019 suspension test for evaluation of bactericidal activity of chemical disinfectants and antiseptics.

11. A fabric, for antimicrobial use, comprising:
a fabric treated with a novel non-alcoholic solvent or solvent mixture,
the solvent or solvent mixture comprising:
curcumin extract,
Syzygium aromaticum extract,
Azadirachta indica extract,
Trachyspermum Ammi extract,
Cinnamomum Camphora extract,
Cinnamomum Verum extract,
Elettaria Cardamomum extract,
citric acid,
Atlantic cod trypsin,
Glycerol, and
sodium chloride.

12. The fabric of claim 11, wherein the solvent or solvent mixture comprises least three ingredients selected from the group consisiting of curcumin extract, Syzygium aromaticum extract, Azadirachta indica extract, Trachyspermum Ammi extract, Cinnamomum Camphora extract, Cinnamomum Verum extract, Elettaria Cardamomum extract, citric acid, Atlantic cod trypsin, glycerol, and sodium chloride.

13. The fabric of claim 11, wherein the solvent or solvent mixture comprises least two ingredients selected from the group consisiting of curcumin extract, Syzygium aromaticum extract, Azadirachta indica extract, Trachyspermum Ammi extract, Cinnamomum Camphora extract, Cinnamomum Verum extract, Elettaria Cardamomum extract, citric acid, Atlantic cod trypsin, glycerol, and sodium chloride.

14. The fabric of claim 11, wherein the solvent or solvent mixture comprises at least one plant extract in oil.

15. The fabric of claim 11, wherein the solvent or solvent mixture is applied to the fabric by a method selected from the group consisting of coating, spraying, embedding, sprinkling, embossing, fogging, and doping.

16. The fabric of claim 11, wherein the solvent or solvent mixture is integrated in the matrix of the fabric.

17. The fabric of claim 11, wherein the fabric comprises a material selected from the group consisting of tissue paper, toilet paper, face towel, diaper, linen, surgical mask, surgical glove, polymerized fabric, leather, plastics, cotton, rubber.

18. The fabric of claim 17, wherein the solvent or solvent mixture is applied to a material selected from the group consisting of footwear, perfume, spray, fragrance, air-freshener, disinfectant, cartonboard, glass, wood, ceramics, cellulose.

19. The fabric of any of claim 11, wherein the fabric is biodegradable.

20. The fabric of claim 19, wherein the fabric is activated in dry-mode.
